(19) United States
(12) Patent Application Publication
(10) Pub. No.: US 2005/0185523 A1
(43) Pub. Date: Aug. 25, 2005

(54) Storage apparatus with a function for displaying volume information

(76) Inventors: Chia-Li Chen, Sindian City (TW); Hsiang-An Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/028,622

(22) Filed: Jan. 5, 2005

(30) Foreign Application Priority Data
Feb. 20, 2004 (TW) 93202429

(51) Int. Cl. G11B 7/007

(52) U.S. Cl. 369/30.1; 369/292

(57) ABSTRACT

The present invention describes a storage apparatus with a function for displaying volume information with at least one built-in storage medium or connecting to at least one outside storage medium, which has a reference block to save the distribution of volume resource. The storage apparatus has an analysis control module, a display unit and a display driving interface. The analysis control module is used to read the reference block and scan the storage medium data to analyze the usage situation, and obtaining latest storage volume information and transmit a display start signal to the display driving interface. Then the display driving interface triggers the display unit, which can display the storage volume information. Therefore, the storage apparatus possesses processing function about volume information and reduces the load of the application system end. The display unit is a bistable display unit that can display on-line, off-line or power off.

### BACKGROUND OF THE INVENTION

1. Field of the Invention

The present invention provides a storage apparatus with a function for displaying volume information, especially to a self-analyzing storage apparatus without an application system. The present invention can analyze a storage volume division area, file system format, and volume label and show data for the same on a display device.

2. Description of Related Art

Large capacity storage devices are made very thin and small, and include portable storage devices such as zip disks, compact disks, memory cards and USB portable hard disks. These storage devices all are used to provide data to a system end and store data. The system end, such as computer, must use a transmission media device such as zip disk player, CD-player or memory card player. But these devices are only used for data transmission, and do not have any other functions.

These storage devices, transmission media devices and portable storage devices have no information display function. Therefore, volume information such as storage volume division area, file system format and volume label, cannot be known by users. The only way to allows users to know the volume information is to connect these storage apparatus to a system end, such as a computer. Users can use an application program to access the volume information of the storage apparatus. But if the storage apparatus is disconnected from the system end or when the system end is shut down, users still know nothing about the storage apparatus.

The USB portable hard disk is now also combined with an MP3 player, so the USB portable hard disk has a small screen. The USB portable hard disk is connected the system end through a USB interface, so it can show information on screen under off-line condition. Furthermore, the USB portable hard disk also uses a battery to provide power to the USB portable hard disk body when the USB body is off-line. However, the information shown on the screen only reveals the music played, and the users still know nothing about the volume information.

The drawback of the prior storage device include:

1. Because users only know the volume information when the storage apparatus is connected to a system end, such as computer, users cannot get information at all times.

2. These storage apparatus cannot self-implement some functions until connected to the system end. The prior art increases the loading of the system end. For example, when one wants to know the volume information of the memory card of a digital camera, he must restart the digital camera just to know the information he wants, thus wasting additional power.

ROC patent publication no. 200300040, published May 1, 2003 (issued on Jun. 11, 2004, ROC Patent No. 591418) still has some drawbacks, which are described as follows:

1. This invention does not consider the power management problem when the storage device is connected to a system end.

2. This invention only shows the space of the storage device, but not other volume information such as storage volume division area, file system format, and volume label.

3. The display unit cannot show data when the display unit is not connected to a system end or when the power is off.

Therefore, the prior invention can only solve some problem of the prior art, but still has some places to be improved.

### SUMMARY OF THE INVENTION

The present invention provides a storage apparatus with a function for displaying volume information, which comprises at least one built-in storage medium or is connected to at least one outside storage medium. The storage medium has a reference block to save the information about volume resource distribution. The present invention of the storage apparatus with a function for displaying volume information at least comprises an analysis control module, a display unit and a display driving interface. The display driving interface is connected to the display unit and the analysis control module.

The analysis control module is used to read the reference block and scan the storage medium data to analyze the loading and usage situation of the storage medium, and also to obtain the latest storage volume information from the read and scan step and transmit a display start signal to the display driving interface. After the display driving interface receives the display start signal, the display driving interface triggers the display unit, and the display unit can display the storage volume information transmitted by the analysis control module.

Therefore, the storage apparatus of the present invention possesses processing function about volume information and reduces the load of the application system end.

The present invention also provides a storage apparatus with a function for displaying volume information, which comprises a built-in bistable liquid crystal display. The bistable liquid crystal display can show the volume information of the storage device when the storage device is on-line, off-line or turned off. A user thus has good control of the volume information.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a block diagram of a preferred embodiment of the present invention; and

FIG. 2 shows a block diagram of another preferred embodiment of the present invention.

### DETAILED DESCRIPTION OF PREFERRED EMBODIMENT

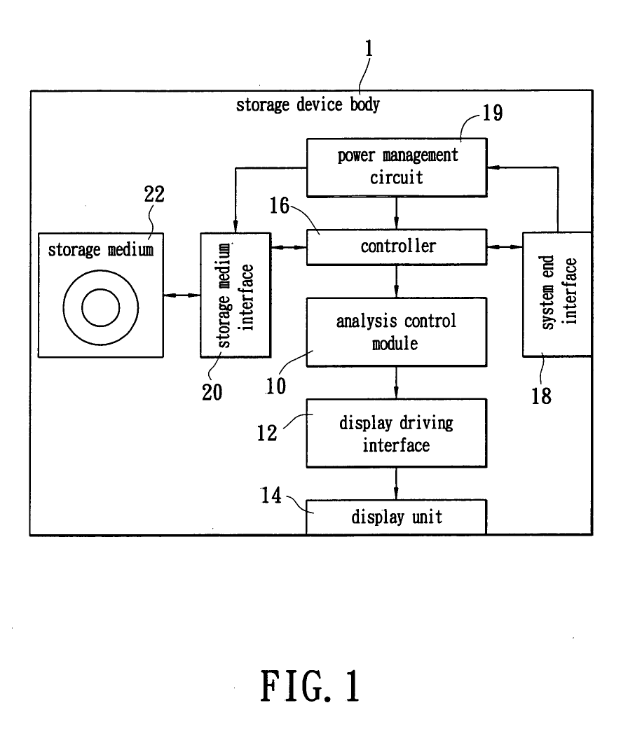

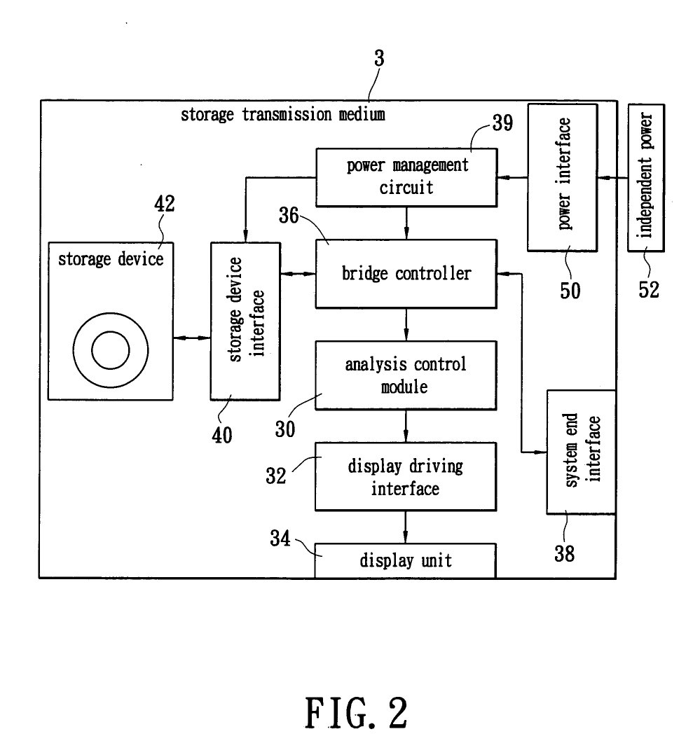

The present invention is a storage apparatus with a function for displaying volume information, the storage apparatus comprising a storage device body 1, and a storage transmission medium 3, as in FIG. 1 and FIG. 2. The storage device body of the present invention means the memory card or any portable storage apparatus, such as a portable hard disk. These portable storage apparatus all at least have a built-in storage medium; the memory card and portable hard disk are storage units made of silicon. The storage transmission medium 3 does not itself have storage media, but is connected to a storage device, as is the device 42 in FIG. 2. The storage transmission medium used to be the interface between application system end and storage device.

Reference is made to FIG. 1, which is a preferred embodiment of the present invention. The storage device body 1 at least comprises an analysis control module 10, a display unit 14 and a display driving interface 12. The analysis control module 10 is used to read the data distribution information inside a storage medium 22.

The distribution information is stored in a reference block of the storage medium 22. The distribution information includes, for example, storage volume division area, file system format, and volume label. File system format is different from the operating system; for example, the DOS system includes FAT12, FAT16, Windows includes FAT32, Windows NT includes NTFS, OS2 includes HPFS and Mac includes HFS. The analysis control module 10 also scans the storage medium 22 to analyze loading and usage situation to know the unoccupied space or occupied space or destroyed space of the storage medium 22. After the latest information of the storage medium 22 is obtained, the analysis control module 10 sends a display start signal to the display driving interface 12, and triggers the display unit 14 to show the storage volume information.

Therefore, the storage device body can get the storage volume information and also reduce the loading of the application system end.

The display unit 14, which is built into the storage device body 1, is a bistability liquid crystal display. The liquid crystal has two different stable states that can be controlled by voltage or distinguished in optics. The storage apparatus will renew the display data, and latch the latest data when power is turned off. Therefore, the bistable display unit can show the latest volume information under on-line, off-line or power off conditions. A user can very conveniently obtain the latest information about the storage device.

The display unit 14 can show the volume information in some ways. One is to use two digits numbers as a percentage, another is to use at least two digits to show a ratio of megabytes (MB) to gigabytes (GB) (MB/GB). Others can use a bar diagram to show the unoccupied space in the storage device or anything that has the same effect.

The present invention does not consume the system end processing procedure and also shows the space information of the storage device.

The storage device body 1 further comprising a system end interface 18, a storage medium interface 20, a controller 16 and a power management circuit 19.

In FIG. 1 the control module 10 and the display driving interface 12 are independently drawn outside the controller 16 for the convenience of illustration, but the two devices 10 and 12 can also be set inside the controller 16. The control module 10 can be designed with a microprocessor (not shown) and an analytical firmware (not shown) or implemented by a hardware circuit.

Reference is made to FIG. 1; the system end interface 18 inside the storage device body 1 is connected to an analysis system, and the system end interface 18 used to transmit instruction to system end. The storage medium interface 20 is electrically connected to the built-in storage medium 22, and the controller 16 is electrically connected to the system end interface 18 and the storage medium interface 20 to receive access instruction from the application system through system end interface 18. The controller 16 also stores volume information in the storage medium 22. Conversely, the volume information from the storage medium 22 is accessed by the application system. The power management circuit 19 is electrically connected to the components mention above; the power management circuit regulates power to make the components mentioned above run properly.

The system end interface 18 is different from the storage device. For example, the portable hard disk uses a USB interface or a FireWire/IEEE1394 interface. The memory card can use PC Card interface, CompactFlash interface, Memorystick interface, SwcureDigital interface or MultiMediaCard interface.

Reference is made to FIG. 2; this figure shows the storage transmission medium 3, comprising an analysis control module 30, a display driving interface 32 and a display unit 34. The difference between FIG. 1 and FIG. 2 is a system end interface 38, which is connected to a normal computer system. The system end interface 38 can be a USB interface or FireWire/IEEE1394 interface. The storage interface is a storage device interface 40 connected to a storage device 42 and at least one storage medium. A bridge controller 36 is electrically connected to the system end interface 38 and the storage device 42. But the bridge controller 36 is only used to transmit data or instructions, which is different from the controller 16 in FIG. 1.

The power management circuit 39 electrically is connected to the components mention above; the power management circuit 39 regulates power to make the components mentioned above run properly. When off-line, the present embodiment also is connected to an independent power 52 through a power interface 50 to make the device run properly.

Although the present invention has been described with reference to the preferred embodiment thereof, it will be understood that the invention is not limited to the details thereof. Various substitutions and modifications have suggested in the foregoing description, and other will occur to those of ordinary skill in the art. For example, replacing the built-in display unit mentioned above of the storage medium with a monitor connected outside. All such substitutions and modifications are intended to be embraced within the scope of the invention as defined in the appended claims.

1. A storage apparatus with a function for displaying volume information, comprising at least one built-in storage medium or connected to at least one outside storage medium, the storage medium having a reference block to save information regarding volume resource distribution, the storage apparatus with a function for displaying volume information comprising:
an analysis control module, used to read the reference block and scan the storage medium data to analyze the loading and usage situation of the storage medium, and obtaining a latest storage volume information from the read and scan step and transmitting a display start signal;
a display unit, used to display the storage volume information when the storage apparatus is off-line, on-line or turned off; and
a display driving interface, connected to the analysis control module and the display unit, the display driving interface used to receive the display start signal and trigger the display unit, wherein the display unit displays the storage volume information transmitted by the analysis control module.

2. The storage apparatus with a function for displaying volume information as in claim 1, wherein the analysis control module is composed of a microprocessor and an analysis firmware.

3. The storage apparatus with a function for displaying volume information as in claim 1, wherein the analysis control module is implemented by a hardware circuit.

4. The storage apparatus with a function for displaying volume information as in claim 1, wherein the display unit is a bistability liquid crystal display.

5. The storage apparatus with a function for displaying volume information as in claim 4, wherein the bistability liquid crystal display renews information when the storage apparatus is on-line.

6. The storage apparatus with a function for displaying volume information as in claim 4, wherein an independent power source provides power to the bistability liquid crystal display, and the bistability liquid crystal display renews the information shown.

7. The storage apparatus with a function for displaying volume information as in claim 4, wherein the bistability liquid crystal display latches and displays a latest storage volume information.

8. The storage apparatus with a function for displaying volume information as in claim 1, wherein the storage apparatus with a function for displaying volume information is a storage device, further comprising:
a system end interface, connected to an application system to read, write, and transmit instructions;
a storage medium interface, electrically connected to the built-in storage medium;
a controller, connected to the system end interface and the storage medium interface, wherein the controller is used to receive and implement an access instruction given from the application system through the system end interface, and store or read data from the storage medium through the storage medium interface to the application system; and
a power management circuit electrically connected to the system end interface, the storage medium interface, and the controller, wherein the power management circuit regulates power to make the system end interface, the storage medium interface, and the controller run properly.

9. The storage apparatus with a function for displaying volume information as in claim 8, wherein the storage device comprises a portable storage device.

10. The storage apparatus with a function for displaying volume information as in claim 8, wherein the analysis control module and the display driving interface are built into the controller or independent from the controller.

11. The storage apparatus with a function for displaying volume information as in claim 1, wherein the storage apparatus with a function for displaying volume information is a storage transmission medium device, further comprising:
a system end interface, connected a application system to read, write, and transmit instructions;
a storage medium interface, electrically connected to the outside storage medium, the outside storage medium having at least a storage medium;
a bridge controller, electrically connected to the system end interface and the storage medium interface, the bridge controller used to receive access instruction sent out from the application system through the system end interface, and store data in storage device through the storage medium interface or transmit data back to application system; and
a power management circuit, electrically connected to the system end interface, the storage medium interface, and the bridge controller, wherein the power management circuit regulates power to make the system end interface, the storage medium interface, and the bridge controller run properly.

12. The storage apparatus with a function for displaying volume information as in claim 1, wherein the storage transmission medium interface further comprises a power interface electrically connected to the power management circuit, and the power management circuit is used to transfer power from an independent power.

13. The storage apparatus with a function for displaying volume information as in claim 11, wherein the analysis control module and the display driving interface are built in or independent from the bridge controller.

14. The storage apparatus with a function for displaying volume information as in claim 1, wherein the information of the reference block to save the distribution of volume resource comprising storage volume division area, file system format, and volume label.

15. The storage apparatus with a function for displaying volume information as in claim 1, wherein the loading and usage situation of the storage medium are calculated and the unoccupied space, occupied space and destroyed space are also calculated.
